(19) United States
(12) Patent Application Publication
(10) Pub. No.: US 2017/0327771 A1
(43) Pub. Date: Nov. 16, 2017

(54) CLEANING COMPOSITION

(71) Applicant: The Procter & Gamble Company, Cincinnati, OH (US)

(72) Inventors: Shanae Elizabeth EASTLAND, Schaerbeek (BE); Claire Emeline IGLESIAS, Saint-Gilles (BE)

(21) Appl. No.: 15/591,688

(22) Filed: May 10, 2017

(30) Foreign Application Priority Data
May 13, 2016 (EP) 16169563.0

(51) Int. Cl. C11D 1/75; C11D 3/33; C11D 3/30; C11D 3/20; C11D 3/04; C11D 11/00; C11D 1/29

(52) U.S. Cl. CPC C11D 1/75; C11D 11/0023; C11D 3/33; C11D 1/29; C11D 3/2068; C11D 3/046; C11D 3/30

(57) ABSTRACT

A hand dishwashing cleaning composition including a) from 20% to 40% by weight of the composition of a surfactant system including an anionic surfactant and amphoteric surfactant in a weight ratio of from about 1:1 to about 3:1 and optionally a non-ionic surfactant wherein if the non-ionic surfactant is present the weight ratio of total surfactant to non-ionic surfactant is greater than 10:1; and b) from about 0.1% to about 3% by weight of the composition of an aminocarboxylic chelant selected from the group consisting of . glutamic-N,N-diacetic acid (GLDA) and its salts, methyl-glycine-diacetic acid (MGDA) and it salts, and mixtures thereof.

### FIELD OF THE INVENTION

The present invention relates to a cleaning composition, in particular a hand dishwashing cleaning composition comprising a specific surfactant system and a specific aminocarboxylic chelant. The composition provides good and easy cleaning, especially grease cleaning.

### BACKGROUND OF THE INVENTION

The detergent formulator is always trying to improve cleaning compositions. In particular, the detergent formulator is always trying to provide compositions that make the cleaning process easier. In hand dishwashing easier cleaning means that the user needs to provide either less strokes when washing or less force to remove the soil, especially greasy soil, from the dishware. It is common practice to soak in diluted detergent dishware soiled with stubborn baked-on greasy soils but even after the pre-soaking step the cleaning performance of traditional detergent might not be satisfactory.

EP 2 264 138 A1 discloses a hand dishwashing detergent composition comprising chelant, anionic surfactant, high level of non-ionic surfactant and amine oxide and/or betaine.

There is still a need for a hand dishwashing cleaning composition that makes manual dishwashing easier when the dishware has not been subjected to pre-soak and also when the dishware has been subjected to a pre-soaking step.

### SUMMARY OF THE INVENTION

According to the first aspect of the invention, there is provided a hand dishwashing cleaning composition, preferably in liquid form. The composition comprises a specific surfactant system and a specific aminocarboxylic chelant. The composition provides good and easy cleaning, even at the earlier stages of the wash. The user does not need to put too much force to remove soil form dishware.

The “surfactant system” of the composition of the invention is herein sometimes referred to as “the surfactant system of the invention”.

The “aminocarboxylic chelant” of the composition of the invention is herein sometimes referred to as “the aminocarboxylic chelant of the invention”.

The surfactant system of the composition of the invention comprises an anionic surfactant and an amphoteric surfactant. The composition can further comprise a non-ionic surfactant. When the composition comprises non-ionic surfactant the weight ratio of total surfactant (i.e.: anionic, amphoteric and non-ionic surfactant) to non-ionic surfactant is greater than 10:1.

The anionic surfactant can be any anionic cleaning surfactant, especially preferred anionic surfactants are selected from the group consisting of alkyl sulfate, alkyl alkoxy sufate, alkyl benzene sulfonate, paraffin sulfonate and mixtures thereof. Preferred anionic surfactants are selected from alkyl sulfate, alkyl alkoxy sulfate and mixtures thereof, a preferred alkyl alkoxy sulfate is alkyl ethoxy sulfate. Preferred anionic surfactant for use herein is a mixture of alkyl sulfate and alkyl ethoxy sulfate.

Extremely useful surfactant systems for use herein include those comprising anionic surfactants, in combination with amine oxide, especially alkyl dimethyl amine oxides.

Preferably, the surfactant system comprises anionic surfactant and amphoteric surfactant, more preferably in a weight ratio of from 1:1 to 3:1, preferably from about 1.5:1 to 2.5:1. More preferably the anionic surfactant is a mixture of an alkyl sulfate and an alkyl ethoxy sulfate and the amphoteric surfactant is an amine oxide and the alkyl sulfate/alkyl ethoxy sulfate mixture and the amine oxide are in a weight ratio of from 1.5:1 to 2.5:1.

The composition of the invention can further comprise non-ionic surfactants. Especially preferred nonionic surfactants are alkyl alkoxylated nonionic surfactants, especially alkyl ethoxylated surfactants.

Especially preferred surfactant systems for the composition of the invention comprise an anionic surfactant preferably selected from the group consisting of alkyl sulfate, alkyl alkoxy sulfate and mixtures thereof, more preferably an alkyl alkoxylated sulfate, most preferably an alkyl ethoxylated sulfate, and an amphoteric surfactant, preferably an amine oxide surfactant. In summary, the most preferred surfactant system for use herein comprises an alkyl alkoxylated sulfate especially an alkyl ethoxylated sulfate surfactant and amine oxide. The composition optionally comprises a non-ionic surfactant, especially an alkyl ethoxylated non-ionic surfactant.

Preferably, the composition of the invention comprises an alkyl ethoxylated sulfate surfactant, alkyl dimethyl amine oxide and an alkyl ethoxylate nonionic surfactant, wherein the weight ratio of total surfactant (i.e.: anionic, amphoteric and non-ionic surfactant) to non-ionic surfactant is greater than 10:1.

Especially good results in terms of cleaning and effort required are obtained when the anionic surfactant and the amphoteric surfactant weight ratio is from 1.5:1 to 2:5 to 1 and the aminocarboxylate chelant is GLDA.

The composition of the invention further comprises an aminocarboxylic chelant. The chelant of the invention can act in combination with the surfactant system of the invention to provide improved grease cleaning and to make the cleaning easier. The aminocarboxylic chelant for use herein is selected from the group consisting of glutamic-N,N-diacetic acid (GLDA) and its salts, methyl-glycine-diacetic acid (MGDA) and it salts, and mixtures thereof. GLDA salts being preferred chelant for use in the composition of the invention.

The composition of the invention can further comprise a salt of a divalent cation. In particular, a salt of magnesium. Magnesium cations can work in combination with the surfactant system and the aminocarboxylic chelant of the invention by strengthening and broadening the grease cleaning profile of the composition.

The composition of the invention can further comprise a cyclic diamine Cyclic diamines can work in combination with the surfactant system and the aminocarboxylic chelant of the invention by strengthening and broadening the grease cleaning profile of the composition.

There is also provided a method of manually washing dishware using the composition of the invention.

### DETAILED DESCRIPTION OF THE INVENTION

### Definitions

As used herein, the singular forms “a”, “an”, and “the” include both singular and plural referents unless the context clearly dictates otherwise.

The term “about” or “approximately” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” or “approximately” refers is itself also specifically, and preferably, disclosed.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

In all embodiments of the present invention, all percentages are by weight of the total composition, as evident by the context, unless specifically stated otherwise. All ratios are weight ratios, unless specifically stated otherwise, and all measurements are made at 25° C., unless otherwise designated.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

The present invention envisages a hand dishwashing cleaning composition, the composition comprises a surfactant system comprising an anionic surfactant and an amphoteric surfactant and an aminocarboxylic chelant selected from the group consisting of glutamic-N,N-diacetic acid (GLDA) and its salts, methyl-glycine-diacetic acid (MGDA) and it salts, and mixtures thereof. The surfactant system and the aminocarboxylic chelant are in a specific weight ratio. The composition optionally comprises a non-ionic surfactant. When present the nonionic surfactant is present in a specific weight ratio compared to the total surfactant. The composition of the invention provides very good cleaning especially grease cleaning without the use of too much force from the user.

### The Cleaning Composition

The cleaning composition is a hand dishwashing cleaning composition, preferably in liquid form. It typically contains from 30% to 95%, preferably from 40% to 90%, more preferably from 50% to 85% by weight of a liquid carrier in which the other essential and optional components are dissolved, dispersed or suspended. One preferred component of the liquid carrier is water.

Preferably the pH of the composition is from about 8 to about 10, more preferably from about 8.5 to about 9.5 as measured at 25° C. and 10% aqueous concentration in distilled water. The pH of the composition can be adjusted using pH modifying ingredients known in the art.

### Surfactant System

The cleaning composition comprises from about 20% to about 40%, preferably from about 20% to about 35% more preferably from about 22% to about 30% by weight thereof of a surfactant system. The surfactant system comprises an anionic surfactant, more preferably an anionic surfactant selected from the group consisting of alkyl sulfate, alkyl alkoxy surfate, especially alkyl ethoxy sulfate, alkyl benzene sulfonate, paraffin sulfonate and mixtures thereof. The system also comprises an amphoteric surfactant.

Alkyl sulfates are preferred for use herein, especially alkyl ethoxy sulfates; more preferably a combination of alkyl sulfates and alkyl ethoxy sulfates with a combined average ethoxylation degree of less than 5, preferably less than 3, more preferably less than 2 and more than 0.5 and an average level of branching of from about 5% to about 40%.

The composition of the invention comprises an amphoteric surfactant, preferably the amphoteric surfactant comprises an amine oxide, preferably an alkyl dimethyl amine oxide. The most preferred surfactant system for the detergent composition of the present invention comprise from 10% to 40%, preferably 13% to 35%, more preferably 15% to 30% weight of the total composition of an anionic surfactant, preferably an alkyl alkoxy sulfate surfactant, more preferably an alkyl ethoxy sulfate, combined with 3% to 15%, preferably from 5% to 12%, more preferably from 7% to 10% by weight of the composition of amphoteric surfactant, more preferably an amine oxide surfactant, especially and alkyl dimethyl amine oxide. Optionally, the composition further comprises a nonionic surfactant, especially an alcohol alkoxylate in particular and alcohol ethoxylate nonionic surfactant. When the composition comprises non-ionic surfactant the weight ratio of total surfactant (i.e.: anionic, amphoteric and non-ionic surfactant) to non-ionic surfactant is greater than 10:1. It has been found that such surfactant system in combination with the aminocarboxylic chelant of the invention provides excellent cleaning especially grease cleaning. Preferably the composition of the invention comprises a mixture of alkyl sulfate and alkyl ethoxy sulfate and alkyl dimethyl amine oxide in a weight ratio of from about 1:1 to about 3:1, preferably from about 1.5:1 to 2.5:1.

### Anionic Surfactant

Anionic surfactants include, but are not limited to, those surface-active compounds that contain an organic hydrophobic group containing generally 8 to 22 carbon atoms or generally 8 to 18 carbon atoms in their molecular structure and at least one water-solubilizing group preferably selected from sulfonate, sulfate, and carboxylate so as to form a water-soluble compound. Usually, the hydrophobic group will comprise a C8-C22 alkyl, or acyl group. Such surfactants are employed in the form of water-soluble salts and the salt-forming cation usually is selected from sodium, potassium, ammonium, magnesium and mono-, di- or tri-C2-C3 alkanolammonium, with the sodium, cation being the usual one chosen.

The anionic surfactant can be a single surfactant but usually it is a mixture of anionic surfactants. Preferably the anionic surfactant comprises a sulfate surfactant, more preferably a sulfate surfactant selected from the group consisting of alkyl sulfate, alkyl alkoxy sulfate and mixtures thereof. Preferred alkyl alkoxy sulfates for use herein are alkyl ethoxy sulfates.

### Sulfated Anionic Surfactant

Preferably the sulfated anionic surfactant is alkoxylated, more preferably, an alkoxylated branched sulfated anionic surfactant having an alkoxylation degree of from about 0.2 to about 4, even more preferably from about 0.3 to about 3, even more preferably from about 0.4 to about 1.5 and especially from about 0.4 to about 1. Preferably, the alkoxy group is ethoxy. When the sulfated anionic surfactant is a mixture of sulfated anionic surfactants, the alkoxylation degree is the weight average alkoxylation degree of all the components of the mixture (weight average alkoxylation degree). In the weight average alkoxylation degree calculation the weight of sulfated anionic surfactant components not having alkoxylated groups should also be included.

Weight average alkoxylation degree=(x1*alkoxylation degree of surfactant 1+x2*alkoxylation degree of surfactant 2+ . . . )/(x1+x2+ . . . )

wherein x1, x2, . . . are the weights in grams of each sulfated anionic surfactant of the mixture and alkoxylation degree is the number of alkoxy groups in each sulfated anionic surfactant.

Preferably, the branching group is an alkyl. Typically, the alkyl is selected from methyl, ethyl, propyl, butyl, pentyl, cyclic alkyl groups and mixtures thereof. Single or multiple alkyl branches could be present on the main hydrocarbyl chain of the starting alcohol(s) used to produce the sulfated anionic surfactant used in the detergent of the invention. Most preferably the branched sulfated anionic surfactant is selected from alkyl sulfates, alkyl ethoxy sulfates, and mixtures thereof.

The branched sulfated anionic surfactant can be a single anionic surfactant or a mixture of anionic surfactants. In the case of a single surfactant the percentage of branching refers to the weight percentage of the hydrocarbyl chains that are branched in the original alcohol from which the surfactant is derived.

In the case of a surfactant mixture the percentage of branching is the weight average and it is defined according to the following formula:

Weight average of branching (%)=[(x1*wt % branched alcohol 1 in alcohol 1+x2*wt % branched alcohol 2 in alcohol 2+ . . . )/(x1+x2+ . . . )]*100

wherein x1, x2, . . . are the weight in grams of each alcohol in the total alcohol mixture of the alcohols which were used as starting material for the anionic surfactant for the detergent of the invention. In the weight average branching degree calculation the weight of anionic surfactant components not having branched groups should also be included.

Suitable sulfate surfactants for use herein include water-soluble salts of C8-C18 alkyl or hydroxyalkyl, sulfate and/or ether sulfate. Suitable counterions include alkali metal cation or ammonium or substituted ammonium, but preferably sodium.

The sulfate surfactants may be selected from C8-C18 primary, branched chain and random alkyl sulfates (AS); C8-C18 secondary (2,3) alkyl sulfates; C8-C18 alkyl alkoxy sulfates (AExS) wherein preferably x is from 1-30 in which the alkoxy group could be selected from ethoxy, propoxy, butoxy or even higher alkoxy groups and mixtures thereof.

Alkyl sulfates and alkyl alkoxy sulfates are commercially available with a variety of chain lengths, ethoxylation and branching degrees. Commercially available sulfates include, those based on Neodol alcohols ex the Shell company, Lial—Isalchem and Safol ex the Sasol company, natural alcohols ex The Procter & Gamble Chemicals company.

Preferably, the anionic surfactant comprises at least 50%, more preferably at least 60% and especially at least 70% of a sulfate surfactant by weight of the anionic surfactant. Especially preferred detergents from a cleaning view point are those in which the anionic surfactant comprises more than 50%, more preferably at least 60% and especially at least 70% by weight thereof of sulfate surfactant and the sulfate surfactant is selected from the group consisting of alkyl sulfates, alkyl ethoxy sulfates and mixtures thereof. Even more preferred are those in which the anionic surfactant is an alkyl ethoxy sulfate with a degree of ethoxylation of from about 0.2 to about 3, more preferably from about 0.3 to about 2, even more preferably from about 0.4 to about 1.5, and especially from about 0.4 to about 1. They are also preferred anionic surfactant having a level of branching of from about 5% to about 40%, even more preferably from about 10% to 35% and especially from about 20% to 30%.

### Sulphonate Surfactant

Suitable sulphonate surfactants for use herein include water-soluble salts of C8-C18 alkyl or hydroxyalkyl sulphonates; C11-C18 alkyl benzene sulphonates (LAS), modified alkylbenzene sulphonate (MLAS) as discussed in WO 99/05243, WO 99/05242, WO 99/05244, WO 99/05082, WO 99/05084, WO 99/05241, WO 99/07656, WO 00/23549, and WO 00/23548; methyl ester sulphonate (MES); and alpha-olefin sulphonate (AOS). Those also include the paraffin sulphonates may be monosulphonates and/or disulphonates, obtained by sulphonating paraffins of 10 to 20 carbon atoms. The sulfonate surfactant also include the alkyl glyceryl sulphonate surfactants.

### Amphoteric Surfactant

Preferred amine oxides are alkyl dimethyl amine oxide or alkyl amido propyl dimethyl amine oxide, more preferably alkyl dimethyl amine oxide and especially coco dimethyl amino oxide. Amine oxide may have a linear or mid-branched alkyl moiety. Typical linear amine oxides include water-soluble amine oxides containing one R1 C8-18 alkyl moiety and 2 R2 and R3 moieties selected from the group consisting of C1-3 alkyl groups and C1-3 hydroxyalkyl groups. Preferably amine oxide is characterized by the formula R1-N(R2)(R3) 0 wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, and linear C12-C14 alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein.

The amine oxide further comprises two moieties, independently selected from a C1-3 alkyl, a C1-3 hydroxyalkyl group, or a polyethylene oxide group containing an average of from about 1 to about 3 ethylene oxide groups. Preferably the two moieties are selected from a C1-3 alkyl, more preferably both are selected as a C1 alkyl.

### Nonionic Surfactant

Nonionic surfactant, when present, is comprised in a typical amount of from 0.1% to 4%, preferably 0.2% to 2%, most preferably 0.3% to 1% by weight of the composition and the weight ratio of total surfactant (i.e.: anionic, amphoteric and non-ionic surfactant) to non-ionic surfactant is greater than 10:1. Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 of ethylene oxide per mole of alcohol. Highly preferred nonionic surfactants are the condensation products of guerbet alcohols with from 2 to 18 moles, preferably 2 to 15, more preferably 5-12 of ethylene oxide per mole of alcohol.

Other suitable non-ionic surfactants for use herein include fatty alcohol polyglycol ethers, alkylpolyglucosides and fatty acid glucamides.

### Aminocarboxylic Chelant

The composition of the invention comprises an aminocarboxylic chelant at a level of from 0.1% to 3%, preferably from 0.2% to 2%, more preferably from 0.5% to 1.5% by weight of the composition.

As commonly understood in the detergent field, chelation herein means the binding or complexation of a bi- or multi-dentate ligand. These ligands, which are often organic compounds, are called chelants, chelators, chelating agents, and/or sequestering agent. Chelating agents form multiple bonds with a single metal ion. Chelants, are chemicals that form soluble, complex molecules with certain metal ions, inactivating the ions so that they cannot normally react with other elements or ions to produce precipitates or scale, or destabilizing soils facilitating their removal accordingly. The ligand forms a chelate complex with the substrate. The term is reserved for complexes in which the metal ion is bound to two or more atoms of the chelant.

Suitable aminocarboxylic chelants are selected from the group consisting of glutamic-N,N-diacetic acid (GLDA) and its salts, methyl-glycine-diacetic acid (MGDA) and it salts, and mixtures thereof. Specially preferred for use herein are salts of GLDA with the tetrasodium salt thereof being especially preferred.

### Cyclic Diamine

The composition of the invention preferably comprises from about 0.1% to about 10%, more preferably from about 0.2% to about 5%, and especially from about 0.3% to about 2%, by weight of the composition of a cyclic diamine. The preferred cyclic diamine for use herein is:

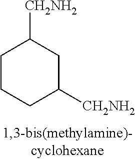

### Divalent Cation

When utilized in the composition of the invention, divalent cations such as calcium and magnesium ions, preferably magnesium ions, are preferably added as a hydroxide, chloride, acetate, sulfate, formate, oxide, lactate or nitrate salt to the compositions of the present invention, typically at an active level of from 0.01% to 1.5%, preferably from 0.015% to 1%, more preferably from 0.025% to 0.5%, by weight of the composition.

### Other Chelants

The composition might further comprise other chelants. Other suitable chelants include other amino acid based compound or a succinate based compound. The term “succinate based compound” and “succinic acid based compound” are used interchangeably herein. Particular suitable chelants include; for example, aspartic acid-N-monoacetic acid (ASMA), aspartic acid-N,N-diacetic acid (ASDA), aspartic acid-N-monopropionic acid (ASMP), iminodisuccinic acid (IDS), Imino diacetic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), alanine-N,N-diacetic acid (ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N, N-diacetic acid (SLDA), taurine-N, N-diacetic acid (TUDA) and sulfomethyl-N,N-diacetic acid (SMDA) and alkali metal salts or ammonium salts thereof. Also suitable is ethylenediamine disuccinate (“EDDS”), especially the [S,S] isomer as described in U.S. Pat. No. 4,704,233. Furthermore, Hydroxyethyleneiminodiacetic acid, Hydroxyiminodisuccinic acid, Hydroxyethylene diaminetriacetic acid are also suitable.

Suitable polycarboxylic acids are acyclic, alicyclic, heterocyclic and aromatic carboxylic acids, in which case they contain at least two carboxyl groups which are in each case separated from one another by, preferably, no more than two carbon atoms. Polycarboxylates which comprise two carboxyl groups include, for example, water-soluble salts of, malonic acid, (ethylenedioxy) diacetic acid, maleic acid, diglycolic acid, tartaric acid, tartronic acid and fumaric acid. Polycarboxylates which contain three carboxyl groups include, for example, water-soluble citrate. Citrate is especially preferred for use in the composition of the invention. Correspondingly, a suitable hydroxycarboxylic acid is, for example, citric acid. Another suitable polycarboxylic acid is the homopolymer of acrylic acid. Preferred are the polycarboxylates end capped with sulfonates.

Amino phosphonates are also suitable for use as chelating agents and include ethylenediaminetetrakis (methylenephosphonates) as DEQUEST. Preferred are these amino phosphonates that do not contain alkyl or alkenyl groups with more than about 6 carbon atoms.

Polyfunctionally-substituted aromatic chelating agents are also useful in the compositions herein. Preferred compounds of this type are dihydroxydisulfobenzenes such as 1,2-dihydroxy-3,5-disulfobenzene.

Further suitable polycarboxylates chelants for use herein include citric acid, lactic acid, acetic acid, succinic acid, formic acid; all preferably in the form of a water-soluble salt. Other suitable polycarboxylates are oxodisuccinates, carboxymethyloxysuccinate and mixtures of tartrate monosuccinic and tartrate disuccinic acid.

Other chelants include homopolymers and copolymers of polycarboxylic acids and their partially or completely neutralized salts, monomeric polycarboxylic acids and hydroxycarboxylic acids and their salts. Preferred salts of the abovementioned compounds are the ammonium and/or alkali metal salts, i.e. the lithium, sodium, and potassium salts, and particularly preferred salts are the sodium salts.

### Hydrotrope

The composition herein optionally comprises a hydrotrope in an effective amount, i.e. from 0% to 15%, or from 0.5% to 10%, or from 1% to 6%, or from 0.1% to 3%, or combinations thereof, so that the liquid dish detergent compositions are compatible or more compatible in water. Suitable hydrotropes for use herein include anionic-type hydrotropes, particularly sodium, potassium, and ammonium xylene sulfonate, sodium, potassium and ammonium toluene sulfonate, sodium potassium and ammonium cumene sulfonate, and mixtures thereof, as disclosed in U.S. Pat. No. 3,915,903. In one embodiment, the composition of the present invention is isotropic. An isotropic composition is distinguished from oil-in-water emulsions and lamellar phase compositions. Polarized light microscopy can assess whether the composition is isotropic. See e.g., The Aqueous Phase Behaviour of Surfactants, Robert Laughlin, Academic Press, 1994, pp. 538-542. In one embodiment, an isotropic dish detergent composition is provided. In one embodiment, the composition comprises 0.1% to 3% of a hydrotrope by weight of the composition, preferably wherein the hydrotrope is selected from sodium, potassium, and ammonium xylene sulfonate, sodium, potassium and ammonium toluene sulfonate, sodium potassium and ammonium cumene sulfonate, and mixtures thereof.

The composition herein may comprise a number of optional ingredients such as preservatives, conditioning polymers, cleaning polymers, surface modifying polymers, soil flocculating polymers, structurants, emollients, humectants, skin rejuvenating actives, carboxylic acids, scrubbing particles, bleach and bleach activators, perfumes, malodor control agents, pigments, dyes, opacifiers, beads, pearlescent particles, microcapsules, antibacterial agents, pH adjusters, buffers, viscosity adjusters including inorganic salts such as NaCl, water or any other diluents or solvents compatible with the composition.

### Method of Washing

The composition of the invention is used in manual dishwashing. The dishwashing method comprises the step of applying the composition, preferably in liquid form, onto the dishware surface, either directly or by means of a cleaning implement, i.e., in neat form.

By “in its neat form”, it is meant herein that said composition is not diluted in a full sink of water. The composition is applied directly onto the surface to be treated and/or onto a cleaning device or implement such as a dish cloth, a sponge or a dish brush without undergoing major dilution (immediately) prior to the application. The cleaning device or implement is preferably wet before or after the composition is delivered to it. The composition can also be applied in diluted form. Both neat and dilute application give rise to good cleaning furthermore less effort is required to obtain good cleaning than when using conventional compositions. Cleaning benefits are observed both when the soiled dishware has been soaked prior to cleaning into a detergent solution, as well as when the dishware was not pre-soaked.

### Examples

### Formula Compositions

The following cleaning compositions were prepared by single mixing of individual compounds. Example 1 represents a composition comprising anionic surfactant, amphoteric surfactant, nonionic surfactant in the weight ratio of the invention combined with an aminocarboxylic chelant according to the invention (GLDA). Comparative Examples 1 to 3 have an anionic surfactant, amphoteric surfactant, nonionic surfactant in a weight ratio outside the scope of the invention and/or don't have the aminocarboxylic chelant according to the invention. Comparative Example 2 represents a formula according to EP 2 264 138 A1.

| | | Comparative | Comparative | Comparative |
|---|---|---|---|---|
| Wt % | Example 1 | Example 1 | Example 2 | Example 3 |
| Total surfactant | 28.6% | 28.6% | 28.6% | 28.6% |
| AES:AO:NI-ratio | 2.2:1:0 | 2.2:1:0 | 3:1:1 | 3:1:1 |
| C1213AE0.6S | 19.7 | 19.7 | 17.4 | 17.4 |
| (AES) | | | | |
| C1214 dimethyl | 8.9 | 8.9 | 5.8 | 5.8 |
| amine oxide (AO) | | | | |
| Neodol 91/8 (NI) | — | — | 5.4 | 5.4 |
| GLDA | 0.9 | — | 0.9 | — |
| NaCl | 0.7 | 0.7 | 1.0 | 1.0 |
| Poly- | 0.8 | 0.95 | 0.25 | 0.35 |
| propyleneglycol | | | | |
| MW 2000 | | | | |
| Ethanol | 1.8 | 1.8 | 1.9 | 1.9 |
| Water and minors | Balance | Balance | Balance | Balance |
| (perfume, dye) | | | | |
| pH (10% dilution | 9.2 | 9.2 | 9.2 | 9.2 |
| in demineralized | | | | |
| water at 20° C.), | | | | |
| trimmed | | | | |
| with NaOH) | | | | |

### Soil Removal and Number of Strokes Required for Soil Removal

From the soil removal percentage and number of strokes required to achieve that soil removal tabulated below it is clear that the composition according to the invention shows a robust grease cleaning performance under both pre-soaking as well as non pre-soaking conditions while comparative Example 1 free of aminocarboxylic chelant according to the invention shows inferior grease cleaning performance under no pre-soaking conditions, and comparative Examples 2 and 3 not comprising the specific surfactant system according to the invention show inferior grease cleaning performance under pre-soaking conditions.

| | | Number of strokes |
|---|---|---|
| | Soil removal | for soil removal |
| | Without pre-soaking | With pre-soaking test |
| Example 1 | 14% | 6.8 |
| Comparative Example 1 | 9% | 7.2 |
| Comparative Example 2 | 15% | 9.2 |
| Comparative Example 3 | 14% | 20.0 |

### Test Method Description

Polymerized Grease Cleaning Test without Pre-Soaking

A soil composition comprising 75% of a blend of vegetable based cooking oils—by weight, ⅓ Wheat germ, ⅓ Sunflower oil and ⅓ Peanut oil—Source: VANDEMOORTELE Belgium), 25% of Albumin powder from Chicken Egg, (Source: White, Grade II—SIGMA) and 0.05% of Oil Red Dye (Lumogen F Rot 305—Source: BASF) was prepared through homogeneously mixing the individual components at room temperature. New tiles were first preconditioned through soiling them as described below, baking them at 135° C. during 2 hrs and consequently cleaning them first with Dreft Original (Belgium) dishwashing liquid detergent followed by a cleaning step with ethanol. This preconditioning process was repeated 4 times prior to using the tiles for polymerized grease cleaning assessment. To evaluate polymerized grease cleaning performance, 0.6-0.7 g of this soil composition was homogeneously applied with a Paint Roller (7 cm length×6 cm diameter) made from synthetic sponge (supplier BRICO, HUBO, GAMMA Belgium), over stainless steel tiles (grade is AISI 304, Source: Lasertek, Belgium) of 8*25 cm. The soiled tiles were consequently baked for 2 h 45 minutes in an oven (WTC Binder Type Series M240 or IP20) set at 135 degrees C., followed by cooling for 24 h at a relative humidity of 70% and 25° C. (Climatic Control Cabinet—Type HC0033 or type VC0033, Source: Heraus Votsch Belgium). The tiles were placed on four cleaning tracks and four sponge holders straight-line sheen machine tester (Wet Abrasion Scrub Tester Ref. 903PG/SA/B—Source: Sheen Instruments Limited). Cellulosic sponges (Artikel Nr. 33100200 Materialnummer Z 1470000 Zuschnitt Schwamm, feinporig 90×40×40—Source: MAPA GmbH—Bereich SPONTEX Industrie Germany), were pre-wetted with demi water (20° C.) and squeezed till no water drained from the sponge anymore (weight sponge: 21 g+/−1 g). Sponges were cut by the supplier to dimensions to fit sponge holders of the cleaning apparatus (9 cm*4 cm). New sponges were boil washed in a washing machine in absence of detergent 3 times prior to use. 10 ml of a 20% weight test product solution in 15 dH water of 20° C. was poured onto a sponge. Four sponges, each comprising a different test product, were placed under normal lab conditions (20° C., 40% rH) on the sponge holder of the sheen machine. A weight of 200 g was placed on top of the sponges and the sheen machine was set at a moving speed of 20 cycles/minute. After 4 cycles a picture of the tile was taken and the % removal was visually assessed through comparing versus a grading scale. The test result of 8 external replicates (i.e. 8 tiles each product tested once on a tile) were averaged and reported. A higher % removal number represents improved grease cleaning efficacy. Testing products were rotated over the different sponge slots between external replicates.

Polymerized Grease Cleaning Test with Pre-Soaking

A soil composition comprising 75% of a blend of vegetable based cooking oils—by weight, ⅓ Wheat germ, ⅓ Sunflower oil and ⅓ Peanut oil—Source: VANDEMOORTELE Belgium), 25% of Albumin powder from Chicken Egg, (Source: White, Grade II—SIGMA) and 0.05% of Oil Red Dye (Lumogen F Rot 305—Source: BASF) was prepared through homogeneously mixing the individual components at room temperature. New tiles were first preconditioned through soiling them as described below, baking them at 135° C. during 2 hrs and consequently cleaning them first with Dreft Original (Belgium) dishwashing liquid detergent followed by a cleaning step with ethanol. This preconditioning process was repeated 4 times prior to using the tiles for polymerized grease cleaning assessment. To evaluate polymerized grease cleaning performance, 0.6-0.7 g of this soil composition was homogeneously applied with a Paint Roller (7 cm length×6 cm diameter) made from synthetic sponge (supplier BRICO, HUBO, GAMMA Belgium), over stainless steel tiles (grade is AISI 304, Source: Lasertek, Belgium) of 8*25 cm. The soiled tiles were consequently baked for 2 h 45 minutes in an oven (WTC Binder Type Series M240 or IP20) set at 135° C., followed by cooling for 24 h at a relative humidity of 70% and 25° C. (Climatic Control Cabinet—Type HC0033 or type VC0033, Source: Heraus Votsch Belgium).

To pre-soak the tiles with a test solution, 10 g of a test solution are added to 1 liter of water at 60° C. and 15 dH water hardness, the resulting pre-soaking solution is poured in a plastic bucket of sufficient size to immerse the tiles (f.e. 28 cm diameter). The tiles were immersed for 10 minutes in the pre-soaking solution, followed immediately by placing the tiles on a four cleaning tracks and four sponge holders straight-line sheen machine tester (Wet Abrasion Scrub Tester Ref. 903PG/SA/B—Source: Sheen Instruments Limited). Cellulosic sponges (Artikel Nr. 33100200 Materialnummer Z 1470000 Zuschnitt Schwamm, feinporig 90×40×40—Source: MAPA GmbH—Bereich SPONTEX Industrie Germany), were pre-wetted with demi water (20° C.) and squeezed till no water drained from the sponge anymore (weight sponge: 21 g+/−1 g). Sponges were cut by the supplier to dimensions to fit sponge holders of the cleaning apparatus (9 cm*4 cm). New sponges were boil washed in a washing machine in absence of detergent 3 times prior to use. 10 ml of a 20% test product solution in 15 dH water of 20° C. was poured onto a sponge. Four sponges, each comprising the same test product, were placed under normal lab conditions (20° C., 40% rH) on the sponge holder of the sheen machine. A weight of 200 g was placed on top of the sponges and the sheen machine was set at a moving speed of 20 cycles/minute. The number of strokes required to clean the soiled tile were counted (end point=visual assessment) and the test result of 8 replicates (i.e. 2 tiles each product tested four times on a tile) were averaged and reported. A lower number of strokes represents improved grease cleaning efficacy. Testing products were rotated over the different sponge slots between external replicates.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A hand dishwashing cleaning composition comprising:
a) from about 20% to about 40% by weight of the composition of a surfactant system comprising an anionic surfactant and amphoteric surfactant in a weight ratio of from about 1:1 to about 3:1 and optionally a non-ionic surfactant wherein if the non-ionic surfactant is present the weight ratio of total surfactant to non-ionic surfactant is greater than 10:1; and
b) from about 0.1% to about 3% by weight of the composition of an aminocarboxylic chelant selected from the group consisting of . glutamic-N,N-diacetic acid (GLDA) and its salts, methyl-glycine-diacetic acid (MGDA) and it salts, and mixtures thereof.

2. A composition according to claim 1 wherein the weight ratio of anionic surfactant to amphoteric surfactant is from about 1.5:1 to about 2.5:1.

3. A composition according to claim 1 wherein the anionic surfactant is selected from the group consisting of alkyl sulfate, alkyl alkoxy sufate, alkyl benzene sulfonate, paraffin sulfonate and mixtures thereof.

4. A composition according to claim 3 wherein the anionic surfactant is selected from the group consisting of alkyl sulfate, alkyl alkoxy sufate, and mixtures thereof.

5. A composition according to claim 4 wherein the anionic surfactant is a mixture of alkyl sulfate and alkyl ethoxy sulfate.

6. A composition according to claim 1 wherein the amphoteric surfactant is an amine oxide.

7. A composition according to claim 6 wherein the amphoteric surfactant is an alkyl dimethyl amine oxide.

8. A composition according to claim 1 wherein the anionic surfactant is an alkyl sulfate, alkyl ethoxy sulfate or a mixture thereof and the amphoteric surfactant is an alkyl dimethyl amine oxide.

9. A composition according to claim 8 wherein the weight ratio of alkyl sulfate, alkyl ethoxy sulfate or a mixture thereof to alkyl dimethyl amine oxide is from about 1.5:1 to about 2.5:1.

10. A composition according to claim 1 wherein the anionic surfactant has an average alkoxylation degree of from about 0.4 to about 1.

11. A composition according to claim 1 wherein the anionic surfactant has an average level of branching of from about 5% to about 40%.

12. A composition according to claim 1 wherein the aminocarboxylic chelant is GLDA or a salt thereof.

13. A composition according to claim 1 wherein the composition further comprises a non-ionic surfactant.

14. A composition according to claim 1 wherein the composition has a pH from about 8 to about 10 as measured at 10% solution in distilled water at 20° C.

15. A composition according to claim 1 wherein the composition further comprises a salt of a divalent cation.

16. A composition according to claim 15 wherein the salt of a divalent cation is a magnesium salt.

17. A composition according to claim 1 wherein the composition further comprises a cyclic diamine.

18. A method of manual dishwashing comprising the step of applying the composition of any of the preceding claims to dishware.
